(19) United States
(12) Patent Application Publication
(10) Pub. No.: US 2014/0298179 A1
(43) Pub. Date: Oct. 2, 2014

(54) METHOD AND DEVICE FOR PLAYBACK OF PRESENTATION FILE

(71) Applicant: TENCENT TECHNOLOGY (SHENZHEN) COMPANY LIMITED, Shenzhen City (CN)

(72) Inventors: Zhengchan Chen, Shenzhen City (CN); Mingfeng Qiu, Shenzhen City (CN); Zhizhi Zhou, Shenzhen City (CN); Wenhao Zhang, Shenzhen City (CN); Zhan Ye, Shenzhen City (CN); Xuan Zhang, Shenzhen City (CN); Ming Lin, Shenzhen City (CN); Shuya Ping, Shenzhen City (CN); Hui Jiang, Shenzhen City (CN); Zhou Zhu, Shenzhen City (CN); Hongxiao Zhu, Shenzhen City (CN)

(21) Appl. No.: 14/304,283

(22) Filed: Jun. 13, 2014

Related U.S. Application Data
(63) Continuation of application No. PCT/CN2013/087939, filed on Nov. 27, 2013.

(30) Foreign Application Priority Data
Jan. 29, 2013 (CN) 2013100337843

(51) Int. Cl. G06F 3/0481

(52) U.S. Cl. CPC G06F 3/0481
USPC 715/730

(57) ABSTRACT

A method and a device for playback of a presentation slide are provided. The method may include receiving uploaded presentation slides to be played back, and converting the presentation slides into slides in video format. The conversion may be performed according to a preset order. Further, a user operation on a speaker client may be detected. A presentation slide corresponding to the user operation may be substantially simultaneously pushed to the speaker client and an audience client. The slide pushed may be the presentation slide converted to the video format. The speaker client and the audience client may substantially simultaneously playback the pushed slide.

This application is a continuation of International application PCT/CN2013/087939, filed on Nov. 27, 2013 which claims the priority to Chinese Patent Application No. 201310033784.3, entitled “METHOD AND DEVICE FOR PLAYING PPT FILE”, filed with the Chinese State Intellectual Property Office on Jan. 29, 2013, which are incorporated by reference in their entirety herein.

### FIELD

The present disclosure relates to the field of network communication, and in particular to a method and a device for viewing a presentation file.

### BACKGROUND

Presentation graphics software, such as PowerPoint (PPT) published by Microsoft Corporation, are, generally, used to prepare slides that may be used during a presentation. At times, users may not be able to attend and view the presentation live. The presentation may be about specific activities, and/or used during collective learning. The users may not be able to attend due to time conflict or geographic region limitation. In such cases, generally, the presentation file that has been shown by a speaker may be converted into a video format and uploaded to the network. A user who wishes to view the presentation may be able to play and view the presentation file on the user's client. Typically, a user may view the presentation slides in the presentation file along with the video presentation of the speaker. However, the slide being viewed by the user and the slide being shown by the speaker are not played synchronously, and the user cannot learn and share the content of the presentation file in a timely manner.

### SUMMARY

A method and a device for viewing, or playing back a presentation, such as a PPT file, are provided according to embodiments of the present disclosure. The technical solutions are as follows.

In one aspect, a method for playing a presentation slide is provided. The method may include at least the following steps.

At least one uploaded presentation slide to be played back may be received. The method may involve converting the received presentation slides into files in video format. The conversion may be performed according to a preset order, such as the order of the slides in the presentation file.

The method may further involve acquiring a user operation on a speaker client. The speaker client may be a device used for presentation on the speaker side. The presentation slide which corresponds to the user operation may be substantially simultaneously pushed to the speaker client and an audience client. The audience client may be a device on the audience side used to view the presentation. The presentation slide may be pushed in form of the converted file in video format for simultaneous playback of the pushed file by the speaker client and the audience client.

In another aspect, a device for playback of a presentation is provided. The device may include a receiving module, a converting module, and a pushing module.

The receiving module may receive at least one uploaded presentation slide.

The converting module may convert the presentation slides into files in video format. The conversion may be performed according to a preset order.

The pushing module may detect a user operation on a speaker client. In response the pushing module may push a presentation slide, which corresponds to the user operation, substantially simultaneously to the speaker client and an audience client for playback. The presentation slide may be pushed in the form of a corresponding file in video format.

According to the technical solutions described in the present disclosure, the user, on a client side, can synchronously view the live broadcast of the presentation file, and the learning efficiency of the user is improved.

### BRIEF DESCRIPTION OF THE DRAWINGS

The accompanying drawings are used in conjunction with the description of the embodiments below. The below description and accompanying drawings explain the technical solutions of the present disclosure. The embodiments described below are only some of the various possible embodiments of the technical solutions. Other drawings and embodiments may be obtained by those skilled in the art, based on the accompanying drawings and description, without any creative work.

FIG. 1 is a flow chart of an example method for synchronously viewing a presentation slide;

FIG. 2 is a flow chart of an example method for synchronously viewing a presentation slide;

FIG. 3 is a schematic diagram of uploaded presentation slides according to an embodiment;

FIG. 4 is a schematic diagram of replacing a presentation slide according to an embodiment;

FIG. 5 is a schematic diagram of storing a presentation slide in video format according to an embodiment;

FIG. 6 is an example timing diagram of synchronization of live broadcast of a presentation slide;

FIG. 7 is an example device for viewing a presentation slide synchronously;

FIG. 8 is an example device for viewing a presentation slide synchronously;

FIG. 9 is an example device for viewing a presentation slide synchronously;

FIG. 10 is an example device for viewing a presentation slide synchronously;

FIG. 11 is another example device for viewing a presentation slide synchronously; and

FIG. 12 is another example device for viewing a presentation slide synchronously.

### DETAILED DESCRIPTION

In order to make the purpose, technical solutions and advantages of the present disclosure clearer, embodiments of the present disclosure are described in further detail below in conjunction with the accompanying drawings.

### First Embodiment

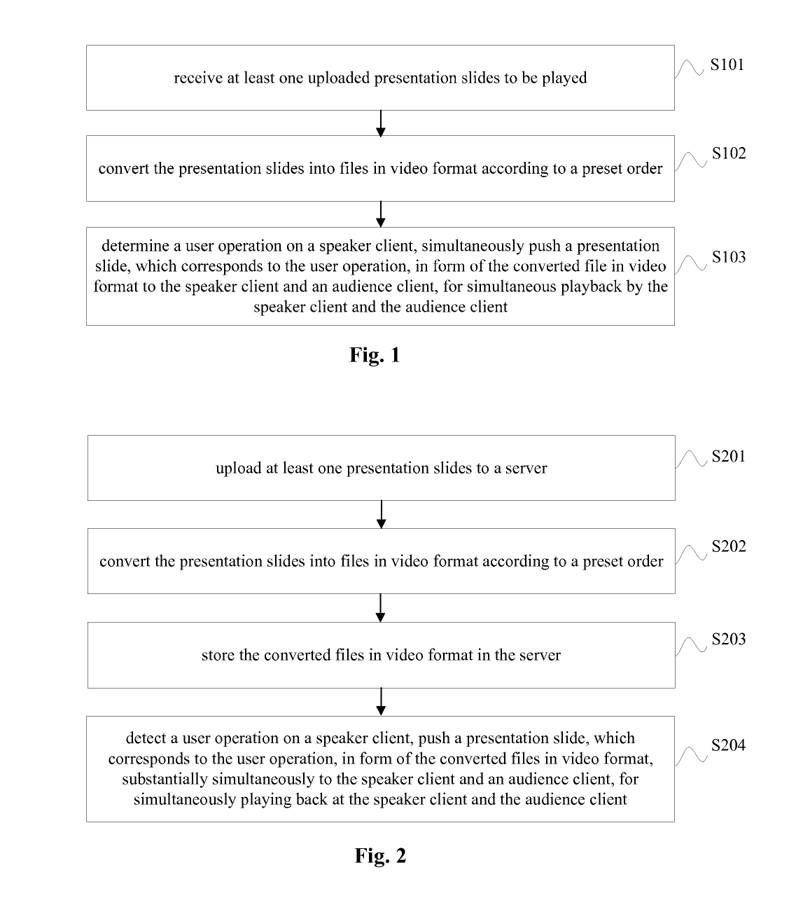

Referring to FIG. 1, a method for viewing a presentation file, such as a PowerPoint (PPT) file, is provided. For sake of simplicity, presentation files are The method may include the following steps 101 to 103.

S101 may involve, receiving at least one uploaded presentation slide to be viewed, or played back.

S102 may involve, converting the presentation slides to be played into files in video format according to a preset order.

The video format may be, for example, WMV (windows media player, a streaming media format published by Microsoft Corporation), MPEG-1 (moving pictures experts group, a VCD format), AVI (audio video interleaved, an audio video interleaved format), and swf (shock wave flash, a special format for animation design software Flash, which is an animation file format supporting vector and raster graphics). The specific video format is not limited herein, and the swf format for Flash is taken as an example in further description.

The method may further include the following steps, which may be performed prior to the conversion of the presentation slides into files of a video format according to a preset order.

For example, the method may involve receiving a modified presentation slide to be played back, and replacing a corresponding original presentation slide with the modified presentation slide.

The conversion of the presentation slides into video format according to a preset order may involve concurrently converting the received presentation slides into corresponding files in video format.

Alternatively, the conversion may involve setting a corresponding priority for each of the received presentation slides to be played back, and sequentially converting the presentation slides into video format files according to the priority of each of the presentation slides.

The method may further involve, receiving a modified presentation slide, after concurrently converting the received presentation slides into video format. The modified presentation slide may be converted into a modified file in video format. In addition, the method may involve acquiring, or detective, or recording, or registering, a user operation on a speaker client, and in response pushing the modified file in video format, substantially simultaneously, to the speaker client and an audience client. The detected user operation may be related to the modified presentation slide, for example a trigger to playback the modified presentation slide. Pushing the corresponding modified video file to the speaker client and audience client may enable substantially simultaneous playback of the pushed video file by the speaker client and the audience client. In this context, pushing the video file may involve transmitting the video file to the respective client over the network. The file may be transmitted in one chunk or in parts such as by streaming the contents of the file using one or more network protocols.

S103 may include, recording a user operation on the speaker client. The presentation slide, which may correspond to the user operation, may be pushed substantially simultaneously, in video format to the speaker client and an audience client. The slide may be pushed in the video format for substantially simultaneous playback of the pushed slide by the speaker client and the audience client. The pushed presentation slide may be the presentation slide converted into a video format.

For example, the user operation may be a page turning operation, corresponding to a particular presentation slide. In response, the presentation slide which corresponds to the user operation, may be identified and further the file in the converted video format, corresponding to the presentation slide may be identified. The file in the converted video format may be pushed to the speaker client and an audience client. Pushing the file may involve forwarding, sending or transmitting the file, either as one chunk or streaming contents of the file using a network protocol. The presentation slide may be pushed to the speaker client and the audience client substantially simultaneously so as to playback the slide at the two clients substantially simultaneously. Using the following steps, pushing the presentation slide in the converted video format may be done substantially simultaneously with the user operation being performed at the speaker client.

The method may involve pushing the presentation slide, which corresponds to the page turning operation substantially simultaneously with a page turning instruction being sent to the speaker client and the audience client. The page turning instruction may instruct the speaker client and the audience client to execute the page turning operation.

Further, pushing a presentation slide substantially simultaneously to the speaker client and an audience client may further include pushing the corresponding file in video format, by using a randomly-generated one-time key.

Thus, an uploaded presentation slide to be played back may be received and converted into video format according to a preset order. A user operation on a speaker client may be recorded, and the presentation slide, corresponding to the user operation, may be substantially simultaneously pushed to the speaker client and the audience client, for substantially simultaneous playback by the speaker client and the audience client. Accordingly, the presentation slide viewed by the user may be played synchronously with the presentation slide being shown by the speaker. Therefore, according to the method provided by the present disclosure, the user may synchronously view the live broadcast of the presentation slide, and the learning efficiency of the user may be improved.

### Second Embodiment

Referring to FIG. 2, a method for synchronously playing back presentation slides is provided, which may include the following steps 201 to 204.

S201 may involve uploading at least one presentation slide to be played back to a server.

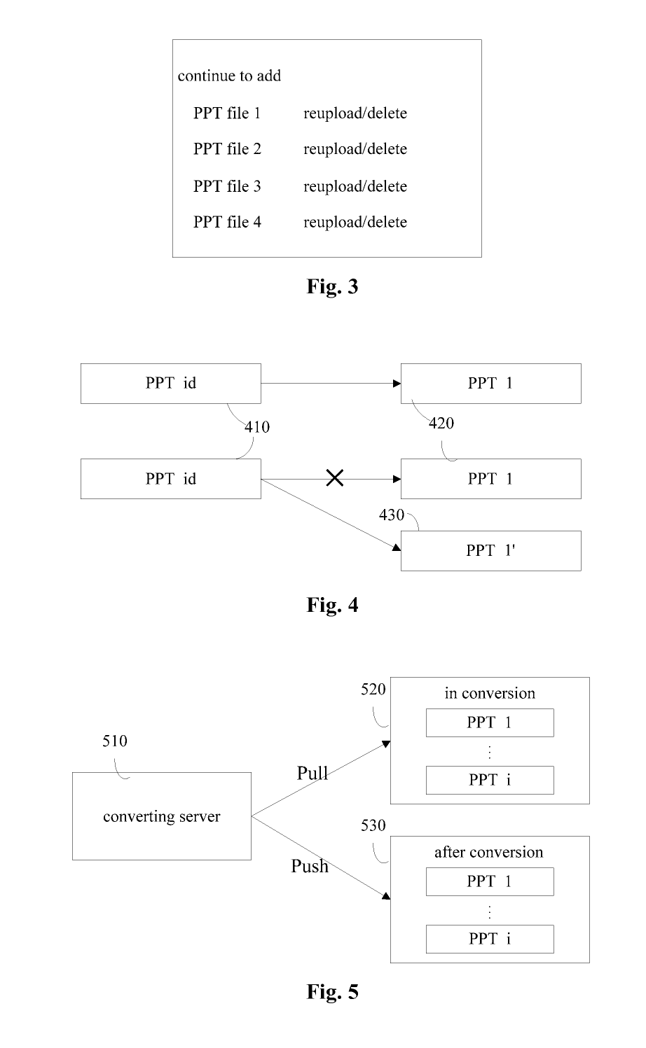

A presentation file, such as a PPT file, may be uploaded in advance to a scheduled time for a presentation using the presentation file to begin. In some cases, the speaker may not finalize the presentation slides, and thus the presentation file until the presentation starts. Hence the presentation file prepared and uploaded in advance by the organizer of the live event may be different from the presentation file finalized and used during the presentation by the speaker. In this case, the uploaded presentation file may be replaced with a new presentation file. Referring to FIG. 3, the presentation file uploaded to the server may contain multiple presentation slides for playback. One or more of the presentation slides may be modified and the latest modified presentation file may be re-uploaded to the server to replace the original presentation file. Furthermore, a new presentation file to be played back may be added directly. However, such operations are to be performed seamlessly such that the live broadcast of the presentation is not affected.

FIG. 4 illustrates an example implementation of a presentation slide replacing function. The presentation slide 420 may be replaced by modifying the content that an identifier of the presentation slide 410, such as a const pointer, points to. In addition, a request to convert the newly added presentation slide 430 may be submitted to a queue for conversion of the presentation slide into the video format.

S202 may involve, converting the presentation slide to be played into the video format according to a preset order.

For updating and replacing the presentation slide without interrupting the live broadcast and without informing the speaker of the current progress of conversion of the presentation, to ensure the live broadcast of the lecture to continue smoothly, the converting request may be extracted from the converting queue, and the presentation slides may be converted concurrently with the live broadcast. That is, the presentation slides to be played back are respectively converted into corresponding video format concurrently by using a format converting tool, such as Ispring. Ispring used in the embodiment is a tool for converting presentation files, such as PPT files, to Flash. Thus, a PPT presentation file may be converted into a file in Flash video format, with the original visualization and animation effect being retained. Other format converting tools may be used to convert the presentation slides into a corresponding video format, and the conversion tool used is not limited herein.

The method may further include, after concurrently converting the received presentation slides into the corresponding video format, receiving a modified presentation slide to be played back. The method may involve converting the modified presentation slide into the video format.

The presentation slides may be converted into the video format by converting the presentation slides concurrently. This may add efficiency.

In order to make the conversion, for example by the format converting tool Ispring, stable and to ensure the conversion effect, serial conversion may be used in an embodiment. Priority may be set for each of the presentation slides, such as according to the playing order of the presentation slides to be played back. The presentation slides to be played back may be converted into files in a video format according to the priority of each of the presentation slides. In the serial conversion, a queue that can be jumped may be formed by a low priority queue and a high priority queue. During the conversion, the priority of a presentation slide may be determined, and the presentation slide with higher priority may be converted first. If the conversion of the presentation slide with high priority is unsuccessful, the slide may enter the high priority queue again, and the slide conversion may be discarded after several attempts.

S203 may involve, storing the converted presentation slides in video format in the server.

Referring to FIG. 5, the converted presentation slides in video format may be stored in the server in a Pull and Push manner in the embodiment. The Pull mechanism refers to pulling, converted part of the presentation file, such as slides 520 that have been converted to corresponding video format, to the server during the conversion. The conversion may be performed by a converting server 510. The Pull operation may ensure normal and timely playback of the presentation slides Pulled. The Push mechanism refers to, before corresponding presentation slides start to be played, pushing the whole converted presentation file, that is all of the slides 530 in the presentation file, to the server after all presentation slides are converted. This may avoid the memory for conversion to be occupied. For example, a presentation page, or slide may correspond to a swf file in video format. The converted swf file may be uploaded to the server in a Pull manner if the conversion of the whole presentation file, that is all slides in the presentation file, is not completed. In case the conversion of all of the presentation slides is completed, all of the converted swf files may be uploaded to the server in a Push manner. The swf files may be stored in a memcache in the server or may be stored in the server as static file by ngnix. The storage manner may be chosen based on server performance and size of the swf file. For example, the swf file may be stored in a memcache in the server if the server performance is low or the size of the swf file in video format is large; and the swf file may be stored in the server as static file by ngnix if the server performance is high or the size of the swf file in video format is small.

S204 may involve, acquiring, or recording a user operation on a speaker client. Further, S204 may involve pushing a presentation slide, which corresponds to the user operation, in the converted video format, substantially simultaneously, to the speaker client and the audience client, for substantially simultaneous playback of the presentation slide by the speaker client and the audience client.

The user operation in the embodiment may be a page turning operation, a pointing operation and other operation, which is not limited herein.

For example, when recording a page turning operation, the presentation slide which corresponds to the page turning operation, in the converted video format may be substantially simultaneously pushed to the speaker client and the audience client. Further, a page turning instruction may be sent to the speaker client and the audience client to instruct the speaker client and the audience client to execute the page turning operation, so as to implement synchronized broadcast of the page turning operation between the speaker client and the audience client. The page turning operation may be a page turning operation from a flip pen or an gesture page turning operation from the speaker client. The presentation may be played back in a full screen mode and the page turning operation may be performed by a flip pen. Due to limitations of the video format, the page turning operation of the flip pen may not be identified if the video is in a full screen mode. In this case, the keyboard event of page up (PgUp) or page down (PgDn) of the flip pen may be captured at the underlying layer of the system to block the keyboard event. The keyboard event of the flip pen may be implemented by triggering a direction key which can be identified by the video format, such as flash. Alternatively, a page turning instruction may be sent to the server according to a gesture operation from the client, and the page turning instruction may be issued to the clients by a page turning synchronization program to perform the page turning operation.

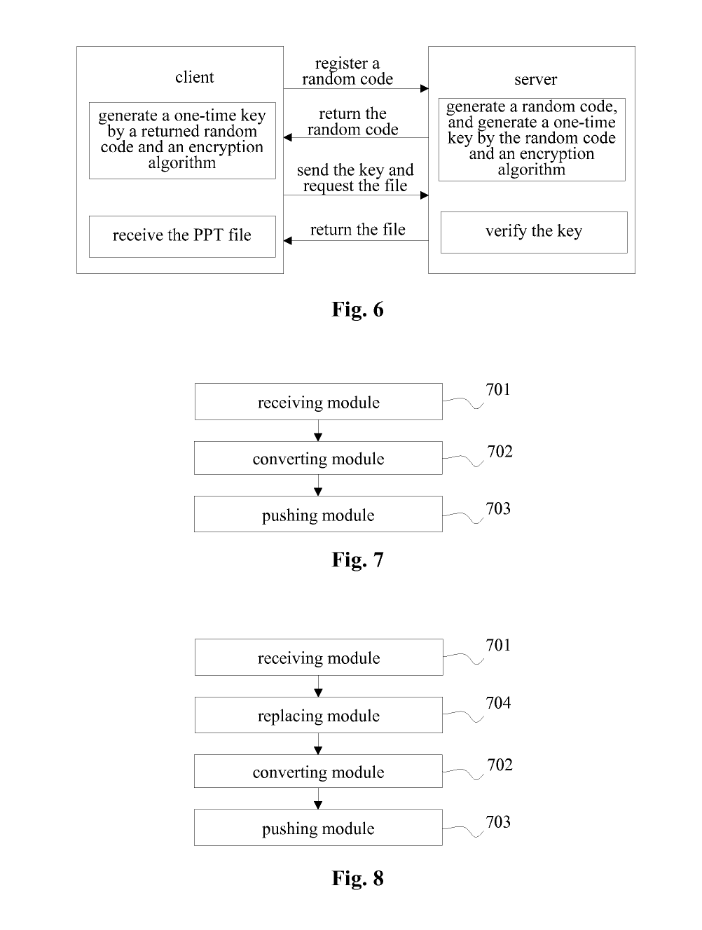

In the embodiment, the presentation slides for the audience may be synchronized with the presentation slides of the speaker based on a subscribe and release mechanism, such as ngnix_httppush_module. A one-time key may be used during synchronization to secure the swf file in video format of the presentation. Referring to FIG. 6, synchronization for the live broadcast may be implemented between the speaker client and the server and between the audience client and the server by using the one-time key, so as to achieve privacy of the presentation file in video format.

A user may express his/her idea and opinion via a chatting window adjacent to the video playing window during the live broadcast of the presentation file in video format. The chatting window may be on the speaker client and the audience client, for communication between the speaker and the audience.

Thus, at least one presentation slide to be played back may be received and converted into video format according to a preset order. A user operation on a speaker client may be detected, or recorded, and the presentation slide, which corresponds to the user operation, is substantially simultaneously pushed to the speaker client and the audience client, in the converted video format, for simultaneous playback of the pushed video file by the speaker to client and the audience client. Accordingly, the presentation, in the form of the video file viewed by the user may be played synchronously with the presentation being shown by the speaker, since users may view on the client side the presentation slide which has been shown by the speaker. Therefore, the user of a client terminal may synchronously view the live broadcast of the presentation slide, and the learning efficiency of the user may be improved.

### Third Embodiment

Referring to FIG. 7, a device for playing a presentation file is provided. The device may include circuitry, such as a receiving module 701, a converting module 702, and a pushing module 703.

The receiving module 701 may receive uploaded presentation slides to be played back.

The converting module 702 may convert the presentation slides to be played back into files in video format according to a preset order.

The pushing module 703 may acquire, or register, or record, a user operation on a speaker client. The pushing module may simultaneously push a presentation slide, which corresponds to the user operation, in the converted video format to the speaker client and an audience client. The pushed presentation slide may be substantially simultaneously played back by the speaker client and the audience client.

Referring to FIG. 8, the device may further include circuitry for a replacing module 704.

The replacing module 704 may receive a modified presentation slide to be played back and replace a corresponding original presentation slide to be played back with the modified presentation file. The replacing module 704 may perform such operations before the converting module 702 converts the presentation slides into video format according to the preset order.

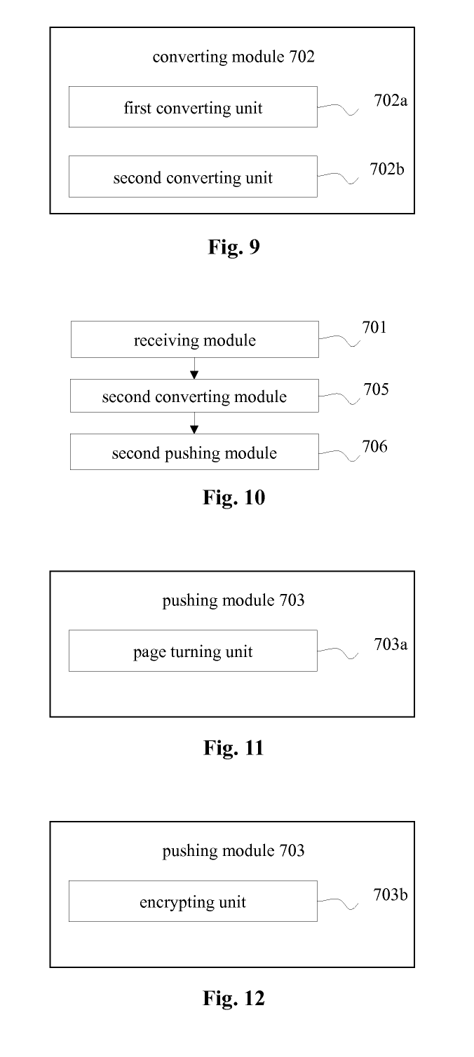

Referring to FIG. 9, the circuitry for the converting module 702 may include a first converting unit 702a and a second converting unit 702b.

The first converting unit 702a may convert the received presentation slides into corresponding files in video format concurrently.

The second converting unit 702b may set a corresponding priority for each of the received presentation slides to be played back. The second converting unit 702b may sequentially convert the presentation slides into video format according to the priority assigned to each of the presentation slides.

Referring to FIG. 10, the device may further include a second converting module 705, and a second pushing module 706.

The second converting module 705 may receive a modified presentation slide to be played back. The second convertible module 705 may convert the modified presentation slide into the video format. Such conversion may be performed after the received presentation slides are concurrently converted into video format.

The second pushing module 706 may acquire, or register a user operation on the speaker client. The second pushing module 706 may substantially simultaneously push the modified presentation slide in video format to the speaker client and the audience client according to the user operation. This may allow for simultaneous playback of the pushed presentation slide by the speaker client and the audience client.

Referring to FIG. 11, the circuitry for the pushing module 703 may further include a page turning unit 703a.

The page turning unit 703a may perform at least the following operations in case the user operation is a page turning operation. The page turning unit 703a may push a presentation slide, which corresponds to the page turning operation, in video format, substantially simultaneously, to the speaker client and the audience client. The page turning unit 703a may, in addition, send a page turning instruction to the speaker client and the audience client, to instruct the speaker client and the audience client to execute the page turning operation.

Referring to FIG. 12, the circuitry for the pushing module 703 may further include an encrypting unit 703b.

The encrypting unit 703b may push the presentation slide corresponding to the user operation, in video format, to the speaker client and the audience client by using a randomly-generated one-time key.

The device provided according to the embodiment, may receive at least one uploaded presentation slide to be played back. The device may convert the presentation slides into video format according to a preset order. Further, the device may record a user operation on a speaker client. The device may identify the presentation slide corresponding to the user operation that has been converted in video format. The device may substantially simultaneously push the identified presentation slide in video format to the speaker client and an audience client, for simultaneously playback of the pushed presentation slide by the speaker client and the audience client. Accordingly, the presentation slide viewed by the user is played synchronously with the presentation slide showed by the speaker. Therefore, users may view, on the respective client of the users, the presentation slide that has been shown by the speaker. Thus, using the device provided by the embodiment, the user may synchronously view the live broadcast of the presentation slide. The learning efficiency of the user may be improved.

The modules are described are named using functions of the live broadcast of the presentation slides in video format. However, the functions described above may be implemented by different circuitry of the device than the modules named. That is, the internal structure of the device may be divided into different function modules to implement all or part of the functions described.

It should be understood by those skilled in the art that, all or part of the steps of the above embodiments may be implemented by hardware, and may also be implemented by relative hardware instructed by a program. The program may comprise instructions executable by one or more processors that may be stored in a non-transitory computer-readable storage to medium. The storage medium may be, for example, a read-only memory, a magnetic disk, an optical disc or any other form of computer readable medium.

What is described above are only some of the various possible embodiments of the present disclosure and is not intended to limit the scope of protection of the present disclosure. Any change, equivalent substitution and improvement made within the spirit and principle of the present disclosure all fall within the scope of protection of the present disclosure.

1. A method for playback of a presentation slide, comprising:
receiving uploaded presentation slides;
converting the presentation slides into corresponding video files in video format according to a preset order of the presentation slides; and
registering a user operation on a speaker client, and pushing a video file corresponding to the user operation, substantially simultaneously to the speaker client and an audience client for simultaneous playback by the speaker client and the audience client, wherein the pushed video file corresponds to one of the presentation slides converted to video format.

2. The method according to claim 1, further comprising:
prior to converting the presentation slides into files in video format:
receiving a modified presentation slide, and
replacing a corresponding original presentation slide with the modified presentation slide.

3. The method according to claim 1, wherein convening the presentation slides into video files in video format further comprises:
concurrently convening the received presentation slides into the corresponding video files in video format; or,
setting a corresponding priority for each of the received presentation slides, and sequentially converting the received presentation slides into the corresponding video files in video format according to the priority of each of the presentation slides.

4. The method according to claim 3, further comprising, after concurrently converting the received presentation slides into the corresponding video files in video format,
receiving a modified presentation slide, and convening the modified presentation slide into a modified video file in video format; and
detecting a user operation on the speaker client, and substantially simultaneously pushing the modified video file in video format to the speaker client and the audience client in response to the user operation, for substantially simultaneous playback of the modified video file by the speaker client and the audience client.

5. The method according to claim 1, wherein, in response to the user operation being a page turning operation, substantially simultaneously pushing a corresponding video file in video format, to the speaker client and an audience client further comprises:
sending a page turning instruction to the speaker client and the audience client, to instruct the speaker client and the audience client to execute the page turning operation.

6. The method according to claim 1, wherein pushing the video file in video format, substantially simultaneously, to the speaker client and an audience client comprises:
pushing the video file in video format to the speaker client and the audience client by using a randomly-generated one-time key.

7. A device for playback of a presentation slide, comprising:
a receiving module, configured to receive uploaded presentation slides;
a converting module, configured to convert the presentation slides into video files in video format according to a preset order; and
a pushing module, configured to detect a user operation on a speaker client, and simultaneously push a video file, which corresponds to the user operation, from among the converted video files, to the speaker client and an audience client for simultaneous playback of the pushed video file at the speaker client and the audience client.

8. The device according to claim 7, further comprising:
a replacing module, configured to, receive a modified presentation slide prior to the conversion of the presentation slides into video files and, in response, the replacing module configured to replace a corresponding original presentation slide with the modified presentation slide.

9. The device according to claim 7, wherein the converting module comprises:
a first converting unit, configured to concurrently convert the received presentation slides into corresponding video files; and
a second converting unit, configured to assign a corresponding priority for each of the received presentation slides, and further configured to convert the presentation slides into video files according to the priority of each of the presentation slides.

10. The device according to claim 9, further comprising:
a second converting module, configured to, receive a modified presentation slide after the received presentation slides are converted into corresponding video files and further configured to convert the modified presentation slide into a modified video file; and
a second pushing module, configured to detect a user operation on the speaker client, and substantially simultaneously push the modified video file to the speaker client and the audience client in response to the user operation, wherein the pushed video file is substantially simultaneously played back at the speaker client and the audience client.

11. The device according to claim 7, wherein the user operation is a page turning operation, and wherein the pushing module comprises:
a page turning unit, configured to, substantially simultaneously push a video file corresponding to the page turning operation, to the speaker client and the audience client, and send a page turning instruction to the speaker client and the audience client, to instruct the speaker client and the audience client to execute the page turning operation.

12. The device according to claim 7, wherein the pushing module comprises:
an encrypting unit, configured to use a randomly-generated one-time key to encrypt a video file prior pushing the video file to the speaker client and the audience client.

13. A non-transitory computer-readable medium storing computer executable instructions, comprising:
instructions to receive presentation slides;
instructions to convert, according to a preset order, the presentation slides into video files in video format; and
instructions to detect a user operation on a speaker client, and substantially simultaneously push a video file, corresponding to a presentation slide of the user operation, to the speaker client and an audience client for substantially simultaneous playback of the pushed video file at the speaker client and the audience client.

14. The non-transitory computer-readable medium according to claim 13, further comprising:
instructions to receive a modified presentation slide before the conversion of the presentation slides to video files, and
instructions to replace a corresponding original presentation slide with the modified presentation slide.

15. The non-transitory computer-readable medium according to claim 13, wherein the instructions to convert the presentation slides into video files comprise:
instructions to concurrently convert the received presentation slides into corresponding video files; or,
instructions to set a corresponding priority for each of the received presentation slides, and sequentially convert the presentation slides into video files according to the priority of each of the presentation slides.

16. The non-transitory computer-readable medium according to claim 15, further comprising:
instructions to receive a modified presentation slide after the concurrent conversion of the received presentation slides, and to convert the modified presentation slide into a modified video file; and
instructions to detect a user operation, corresponding to the modified presentation slide, on the speaker client, and in response, pushing the modified video file substantially simultaneously, to the speaker client and the audience client for playback.

17. The non-transitory computer-readable medium according to claim 13, wherein, the user operation is a page turning operation, and the instructions to push the video file comprises:
instructions to push the video file , substantially simultaneously, to the speaker client and the audience client, and to send a page turning instruction, substantially simultaneously, to the speaker client and the audience client, to instruct the speaker client and the audience client to execute the page turning operation.

18. The non-transitory computer-readable medium according to claim 13, wherein the instructions to push a video file comprises instructions to use a randomly-generated one-time key to encrypt the video file prior to transmitting the video file.
